(19) United States
(12) Patent Application Publication
(10) Pub. No.: US 2021/0005109 A1
(43) Pub. Date: Jan. 7, 2021

(54) Chinese Language Teaching Material

(71) Applicant: CHOJOGAKUIN Co., Ltd., Tokyo (JP)

(72) Inventor: Ji Zhang, Tokyo (JP)

(21) Appl. No.: 16/963,932

(22) PCT Filed: Apr. 10, 2019
(86) PCT No.: PCT/JP2019/015640

§ 371 Date: Jul. 22, 2020

(30) Foreign Application Priority Data
Apr. 10, 2018 (JP) 2018-075468

(51) Int. Cl. G09B 19/08

(52) U.S. Cl. CPC G09B 19/08

(57) ABSTRACT

A printed matter of Chinese teaching material includes: a Chinese character reading part 50 that has a Chinese character displayed together with Chinese pinyin in a character frame 90a that is a syllable length symbol relatively indicates length per unit time to pronounce Chinese character; a word pronunciation part 60 that has a word displayed in a character frames 90b that respectively has the same sizes and are equal to or smaller than the character frame 90a displayed in the Chinese character reading part 50; and a conversation pronunciation part 70 that has a sentence displayed in a character frames 90c that respectively has the same sizes and indicates that the length and width are a half of the character frame 90b displayed in the word pronunciation part 60.

### TECHNICAL FIELD

This invention relates to Chinese teaching material for learning Chinese.

### BACKGROUND OF THE INVENTION

Existing Chinese teaching for Japanese learners uses “Chinese Pinyin (Chinese words written using the Roman alphabet)” that consists of two syllables to teach a Chinese character that originally has only one syllable, and teaches pronunciation of Chinese while explaining the structures of pronunciation. This teaching method is basically the same as the teaching method for Chinese elementary school students (for example, patent document 1).

### CITATION LIST

### Patent Document

PATENT DOCUMENT 1: JP Patent No. 6126339

### SUMMARY

However, such conventional methods are suitable for Chinese elementary school students, but not suitable for Japanese learners. Chinese elementary school students have already mastered the pronunciation of Chinese characters before learning the Chinese characters, so after learning the pronunciation structures using “Chinese Pinyin”, they can easily restored them to the original one syllable Chinese characters' pronunciation correctly.

On the other hand, for a Japanese learner, it is possible to expand a Chinese character into two syllables consisting of a consonant and a vowel using the Chinese Pinyin pronunciation expansion method, but for the Japanese learner it is almost impossible to restore them to the “pronunciation of Chinese characters” of one syllable. The reason is that Japanese cannot pronounce Chinese characters (Chinese pronunciation) by using original pronunciation.

Therefore, Chinese spoken by a Japanese learner became something different from Chinese that originally consists of one syllable, and not understandable to Chinese people.

In order to solve the above problems, the present invention aims to provide a Chinese teaching material that allows a non-native Chinese language learner to easily acquire correct Chinese pronunciation.

In one aspect of the Chinese teaching material according to the present invention includes: a Chinese character reading part that displays a Chinese character and Chinese pinyin of the Chinese character, the Chinese character being displayed together with a syllable length symbol that relatively indicates the length of the Chinese character; a word pronunciation part that displays a plurality of Chinese characters including the Chinese character displayed in the Chinese character reading part, each Chinese character being displayed together with the syllable length symbol, the syllable length symbols indicating that the length of pronunciation for each of the Chinese characters displayed in the word pronunciation part is even, and the length of the pronunciation is equal to or shorter than the length of pronunciation of the Chinese character displayed in the Chinese character reading part; and a conversation pronunciation part that displays a plurality of Chinese characters including the Chinese character displayed in the Chinese character reading part, each Chinese character being displayed together with the syllable length symbol, the syllable length symbols indicating that the length of pronunciation for each of Chinese characters displayed in the conversation pronunciation part is even, and the length of the pronunciation is equal to a half of the length of pronunciation for each of the Chinese characters displayed in the word pronunciation part, wherein the Chinese character reading part, the word pronunciation part, and the conversation pronunciation part are arranged side by side from left to right in a page in the order of the Chinese character reading part, the word pronunciation part, and the conversation pronunciation part, wherein the syllable length symbol is a rectangular frame, each of the Chinese characters being displayed inside the frames, the width of the rectangular frames of the word pronunciation part being equal to or shorter than the rectangular frame of the Chinese character reading part, the width of the rectangular frames of the conversation pronunciation part being a half of the rectangular frame in the Chinese character reading part.

According to this aspect, since a Chinese character and its Chinese pinyin are displayed in the Chinese character reading part, correct Chinese character reading of the can be acquired. In the word pronunciation part, Chinese words are displayed along with syllable length symbols that are equal to or smaller than the syllable length symbol used in the Chinese character reading part. This syllable length symbol is used for each Chinese character that makes up the words, and the syllable length symbols are the same in size. Therefore, a learner can visually understand that each single syllable of the Chinese character that makes up the words is even, and can acquire correct word pronunciation as learned in the Chinese character reading part. Furthermore, in the conversation pronunciation part, Chinese sentences are displayed along with syllable length symbols that length and width are a half of the syllable length symbol used in word pronunciation part. In this case, the syllable length symbols are also the same in size. Therefore, the learner can visually understand that each single syllable of the Chinese character that makes up the Chinese sentences is even, and can acquire the correct conversation pronunciation as learned in the word pronunciation Part.

Another aspect of the Chinese teaching material according to the present invention includes: another conversation pronunciation part that is arranged in the page and on the right side to the conversation pronunciation part together with the Chinese character reading part, the word pronunciation part, and the conversation pronunciation part, wherein said another conversation pronunciation part displays a plurality of Chinese characters including the Chinese character displayed in the Chinese character reading part, each of the Chinese characters being displayed together with the syllable length symbol, the syllable length symbols indicating that the length of pronunciation for each of the Chinese characters is even, and the length of the pronunciation is a quarter of the length of pronunciation for each of the Chinese character displayed in the word pronunciation part, wherein the syllable length symbol of said another conversation pronunciation part is rectangular frame, each of the Chinese characters being displayed in the frames, and the width of the rectangular frame of said another conversation pronunciation part is a quarter of the width of the rectangular frame in the Chinese character reading part.

In another aspect of the Chinese teaching material of the present invention, Chinese characters that the pronunciations thereof are the same but the four tones thereof are different are listed together with the syllable length symbols in the Chinese character reading part.

Another aspect of the Chinese teaching material of the present invention includes a grammar comparison part that displays conversational sentences and the Japanese translations of the conversational sentences, wherein in the grammar comparison part, portions of different word order between Chinese and Japanese are displayed in color different from one for other characters.

In another aspect of the Chinese teaching material of the present invention a Chinese character that is the same as a Japanese kanji, which is a Chinese character used in Japan, is displayed in black, while a distinctive Chinese character that is different from the Japanese kanji is displayed in red.

According to the Chinese teaching material in the present invention, the learner can visually understand the uniformity of one syllable length and the correct one syllable length in word pronunciation and conversation pronunciation in Chinese, which helps them to learn efficiently and easily.

### BRIEF DESCRIPTION OF THE DRAWINGS

FIG. 1 shows an example of Chinese teaching material in one embodiment of the present invention.

FIG. 2 explains the correct one syllable length of Chinese characters pronounced by a Chinese person.

FIG. 3 explains the wrong one syllable length of Chinese characters pronounced by a Japanese person.

### DESCRIPTION OF EMBODIMENTS

Hereinafter, an embodiment of the present invention will be described with reference to the attached drawings.

### Principle of the Present Invention

Chinese characters consist of “sound”, “shape” and “meaning”, in the present embodiment, the “sound” included in Chinese character itself will be named “Chinese character reading”. The “Chinese character reading” has two features, one is that all of them are “monosyllabic pronunciation”, the other is that the “Chinese pronunciation and Chinese character reading match exactly”.

The monosyllabic Chinese character reading includes “consonant”, “vowel” and “four tones”, this Chinese character reading can be decomposed into “consonant”, “vowel” and “four tones” by using a tool called “Chinese Pinyin”. However, “Chinese Pinyin” may not be monosyllabic because it is expressed by alphabets representing consonants and alphabets representing vowels.

Therefore, when learning Chinese characters using “Chinese Pinyin”, one has to divide Chinese character reading of one syllable into two syllables using “Chinese Pinyin”, then learn the “consonant”, “vowel” and “four tones” before restoring them to one syllable.

For example, the reading of Chinese character “zhang (Since it is impossible to describe the Chinese character in this specification, the alphabets are used)” is one syllable, but if it is expressed by “Chinese Pinyin”, it becomes zhang (the four tones is omitted), one syllable of “zh” and another syllable of “ang” make two syllables.

In the case of Chinese people, even elementary school students have mastered Chinese character reading before learning them, so there is no problem even with such a learning method using “Chinese Pinyin”.

However, in Japanese, “consonant” and “vowel” are always combined, and there is a long sound that does not exist in Chinese, so if a Japanese learned “consonant”, “vowel” and “four tones” using two syllables expressed by “Chinese Pinyin”, he or she will be not able to restore them to one syllable Chinese character reading after that.

As a result, when he or she pronounces a Chinese sentence, length of the sound of the Chinese character reading is uneven, resulting in the pronunciation not comprehensible to Chinese people.

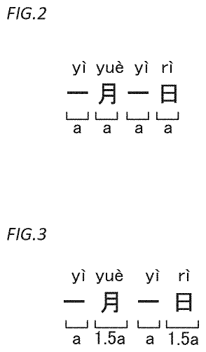

For example, in the case of the Chinese phrase “January 1 (Since it is impossible to describe the Chinese characters in this specification, the alphabets and the number are used. In the original Chinese characters, the ones meaning “Month” and “Day” are included.)”, the lengths of the sound of the Chinese character readings for “1”, “Month”, and “Day” are the same, as shown in FIG. 2.

In FIG. 2, the length of the sound is indicated by “a”. However, when a Japanese person pronounces this phrase, as displayed in FIG. 3, the length of the sound of each Chinese character reading is uneven, resulting in a pronunciation not comprehensive to Chinese people.

Therefore, in the present invention, by introducing rectangular frame as a syllable length symbol representing syllable length in the Chinese teaching material, thus making it possible to learn Chinese monosyllabic character reading. In this embodiment, the syllable length symbol is named “character frame”.

Next, the principle of enabling a learner to acquire the speed of one syllable in the present invention will be described. Generally speaking, a Chinese TV presenter speaks 220-240 characters per minute, and duration of one syllable is about 0.25 seconds. Assuming that one syllable lasts 1 second when learning Chinese character reading with Pinyin, it will lead to natural Chinese word pronunciation by making one syllable last 0.5 second. Furthermore, by shortening the duration of one syllable to 0.25 seconds, it becomes natural Chinese speech pronunciation.

Therefore, the present invention, firstly, enables a learner to acquire “consonant”, “vowel” and “four tones” of Chinese character reading using “Chinese Pinyin”. In this case, a Chinese character is surrounded by the “character frame” that is a syllable length symbol, and “Chinese Pinyin” is also displayed in the “character frame”. Secondly, on its right side, it enables a learner to acquire word pronunciation using “character frame” that is equal to or smaller than the “character frame” used for the “Chinese Pinyin”. Then, on its right side, the “character frame” used for the word pronunciation is used to enable a learner to acquire conversational pronunciation.

In this case, assuming that the duration of one syllable to be practiced using “Chinese Pinyin” is 1 second, instead of reducing the duration of one syllable to 0.5 seconds or 0.25 s second all at once, at first, in word pronunciation, perform practice in one second as is the case in practicing one syllable in “Chinese Pinyin”, then make the duration 0.5 seconds per syllable and finally 0.25 seconds per syllable in conversation practice. In this way gradual practice will become possible. Moreover, since the “character frame” is used and the length of each Chinese character reading is even, it is possible to visually understand that the speed of one syllable gradually increases.

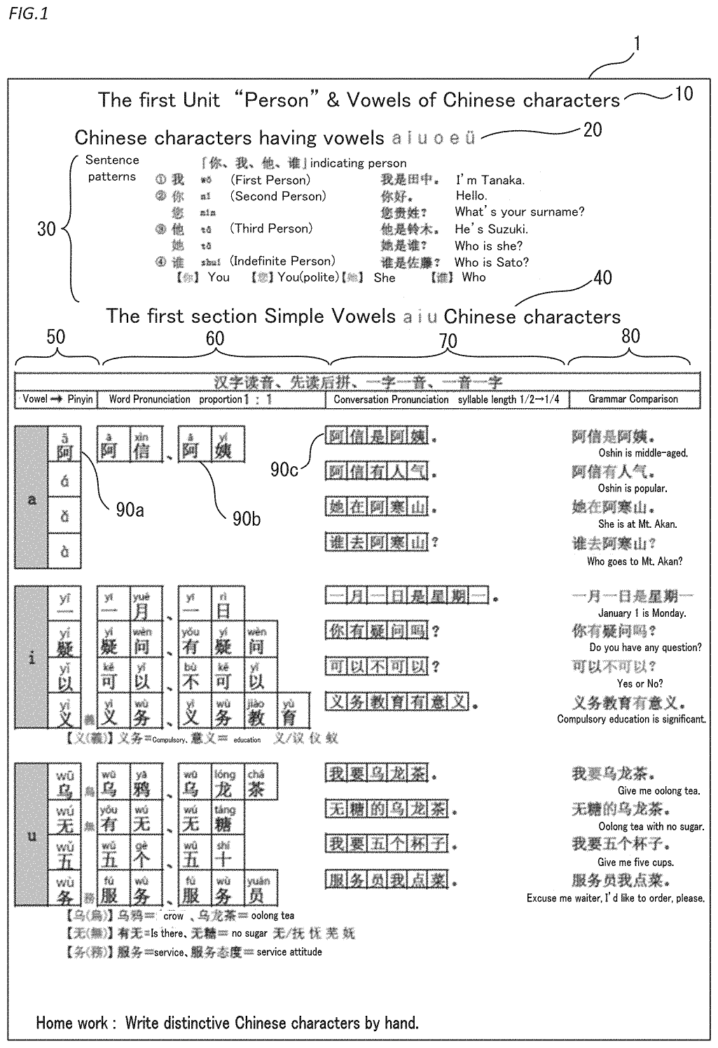

Hereinafter, based on a specific embodiment, an example of a Chinese teaching material prepared according to the above-described principle of the present invention will be described. FIG. 1 shows an example of a page of Chinese teaching material according to the present embodiment. As shown in FIG. 1, Chinese teaching material 1 of this embodiment includes a unit title displaying part 10 that is located at the top of the page, and a vowel or consonant displaying part 20 that displays vowel or consonant of the Chinese character to be acquired in this unit, and a sentence pattern displaying part 30 that displays sentence pattern to be acquired in this unit, and a section title displaying part 40 that displays a section title, a Chinese character reading part 50, a word pronunciation part 60, a conversation pronunciation part 70, and a grammar comparison part 80.

In the unit title displaying part 10, the number of each unit of the Chinese teaching material 1, and contents to be learned in the unit are described. In the vowel or consonant displaying part 20, vowels or the consonants of the Chinese characters to be acquired in the unit are described.

In the sentence pattern displaying part 30, a sentence pattern to be acquired in the unit is described. In the section title displaying part 40, the number of each section and the type of the Chinese character to be acquired in each section are described.

In the Chinese character reading part 50, a Chinese character along with Chinese Pinyin is described. In the Chinese character reading part 50, four tones of the one Chinese Pinyin are displayed in the vertical direction of the page. The Chinese character and the Chinese Pinyin are surrounded by the character frame 90a. The space where the Chinese character is not displayed in the character frame 90a is the case that the Chinese character corresponding to the Chinese Pinyin does not exist. When all of the Chinese characters corresponding to the four tones of the Chinese Pinyin do exist, it is possible to learn all the four tones with the same pronunciation and to learn Chinese characters corresponding to the four tones. By learning with the Chinese character reading part 50, a learner can acquire correct Chinese character reading.

In the word pronunciation part 60, a word including the Chinese character displayed in the Chinese character reading part 50 is described. Each Chinese character that makes up the word is surrounded by the character frame 90b. The size of the character frames 90b is equal to or smaller than the character frame 90a in the Chinese character reading part 50. In the example shown in FIG. 1, the character frame 90a in the Chinese character reading part 50 and the character frame 90b in the word pronunciation part 60 are the same size, and the sizes of the character frames 90b in the word pronunciation part 60 are the same for each Chinese character. Therefore, a learner can learn understand the correct pronunciation of the Chinese character the learner learned in the Chinese character reading part 50 without changing the one syllable length, and can learn visually understand that the one syllable length is even in each Chinese character. Consequently, the learner can acquire the correct word pronunciation.

In the conversation pronunciation part 70, a sentence including the word displayed in the word pronunciation part 60 is described. Each Chinese characters that making up the sentence is surrounded by the character frame 90c. As for the size of the character frame 90c, its height and width are half of the character frame 90b in the word pronunciation part 60. The sizes of the character frames 90b in the conversation pronunciation part 70 are the same for each Chinese character. Therefore, a learner can visually understand the followings in relation to the correct word pronunciation the learner learned in the word pronunciation part 60:

The one syllable length of the Chinese characters that make up the word is a half of one indicated in the word pronunciation part 60; and
the one syllable length is even in each Chinese character.
Therefore, the learner can acquire correct conversation pronunciation.

In the example of FIG. 1, only one conversation pronunciation part 70 is provided due to the layout and the size of the page, but if the layout and the size of the page allow, another conversation pronunciation part may be provided to the right of the conversation pronunciation part 70. In this other conversation pronunciation part, a sentence which is the same as one displayed in the conversation pronunciation part 70 is displayed. Then, the size of the character frame surrounding the Chinese characters that make up the sentence is made to be half of the height and the width of the character frame 90c displayed in the conversation pronunciation part 70. By configuring in this manner, a learner can visually understand the followings in relation to the correct conversation pronunciation the learner learned in the conversation pronunciation part 70:

The one syllable length of the Chinese characters that make up the word is a half of one indicated in the conversation pronunciation part 70; and
the one syllable length is even in each Chinese character.
Therefore, the learner can acquire correct and natural conversation pronunciation.

As in the example of FIG. 1, when the above-mentioned another conversation pronunciation part cannot be arranged, if an instructor instructs a learner to halve the one syllable length of the Chinese character in the sentence practiced in the conversation pronunciation part 70, the learner will be able to acquire correct and natural conversation pronunciation easily. Also in this case, a learner will be able to easily imagine in the learner's head that the one syllable length becomes a half of one indicated in the conversation pronunciation part 70 by practicing the conversation pronunciation while watching the character frame 90c displayed in the conversation pronunciation part 70. Therefore, the learner will be able to acquire correct and natural conversation pronunciation while making the one syllable length even.

In the grammar comparison part 80, the Japanese translation of the sentence displayed in the conversation pronunciation part 70 is displayed under Chinese. Although it is not easy to recognize in FIG. 1 because it is drawn in black and white, in the grammar comparison part 80, portions where the word order differs between Chinese and Japanese are highlighted in color different from other characters. This allows the learner to easily understand the difference in word order between Chinese and Japanese. Also, although it is not easy to recognize in FIG. 1 because it is drawn in black and white, in the grammar comparison part 80, Chinese characters that are the same as Japanese kanjis (Chinese characters used in Japan.) are displayed in black, while Chinese characters that are different from Japanese kanjis are displayed in red. Thus, the learner can acquire distinctive Chinese characters efficiently.

The number of commonly used Chinese characters is about 2500, and the Chinese teaching material 1 of the present invention mainly includes these 2500 commonly used Chinese characters, and for example, it is divided into four volumes. For example, in the first volume, 900 commonly used Chinese characters are included, and among them, there are 300 distinctive Chinese characters. In the second volume, 800 commonly used Chinese characters are included, and there are 300 distinctive Chinese characters among them. Furthermore, in the third volume 800 commonly used Chinese characters are included, and there are 200 distinctive Chinese characters among them. And the fourth volume includes 240 polyphony characters that have more than one pronunciation.

In Chinese, there are six simple vowels and complex vowels, and 23 consonants. In addition, there are approximately 1200 readings in total. In the Chinese teaching material 1 of the present invention, as an example, in addition to vowels and complex vowels, there are 23 units, in each of which each of the 23 consonants is allocated, so that the learner can concentrate on learning the pronunciation of each consonant. By learning one volume of the Chinese teaching material 1 of the present invention, it is possible to master about 1,200 readings. By learning three more volumes, the learner can learn three times repeatedly.

As for the entire structure of the Chinese teaching material 1, for example, all Chinese vowels including simple vowels such as a, i, u and e, and complex vowels such as an, ang and ai are included in the first unit. Then, in the second unit and thereafter, the combinations of all Chinese consonants such as b, p, m, f, d, etc. and the Chinese vowels are included. By configuring the overall structure in this manner, in the first unit, the learner can learn all Chinese vowels with correct Chinese pronunciation and in the second unit and thereafter, the learner can learn all consonants with correct Chinese pronunciation by combining them with Chinese vowels. Moreover, since the pronunciation of each Chinese vowel is repeatedly displayed in the order of four tones in the Chinese character reading part 50 of each page, while learning the entire Chinese teaching material 1, the learner will be able to master correct four tones naturally. As described above, by learning the entire Chinese teaching material 1 of the present invention, it will be possible for the learner to acquire correct Chinese pronunciation by all Chinese vowels and all of the combinations of Chinese vowels and Chinese consonants.

As described above, according to the Chinese teaching material 1 of the present invention, the syllable length symbol called Character frame is used in it, and in the order of the Chinese character reading part 50, the word pronunciation part 60, and the conversation pronunciation part 70, the character frames are displayed in appropriate sizes suitable to each part. Therefore, the learner can visually understand the uniformity of one syllable and the shortening of the one syllable length, and acquire correct Chinese character reading, correct word pronunciation, and correct and natural conversation pronunciation easily and properly.

In the embodiment described above, the aspect of realizing the Chinese teaching material 1 as a paper book has been described, however, the present invention is not limited to this aspect, and it is possible to realize it as an application of a computer or a smartphone.

The embodiments described above are merely illustrative examples, and many various modifications are possible without departing from the scope of the present invention. Although the plurality of embodiments described above can be implemented independently, it is also possible to combine the embodiments as well. In addition, various features in different embodiments can be stand alone, while combinations of features in different embodiments are also possible.

The present invention can be applied to the field of producing Chinese teaching materials.

### DESCRIPTION OF THE REFERENCE NUMERALS

1 Chinese teaching material

50 Chinese character reading part

60 word pronunciation part

70 conversation pronunciation part

80 grammar comparison part

1. A printed matter of Chinese teaching material comprising:
a Chinese character reading part that displays a Chinese character and Chinese pinyin of the Chinese character, the Chinese character being displayed together with a syllable length symbol that relatively indicates the length of the Chinese character;
a word pronunciation part that displays a plurality of Chinese characters including the Chinese character displayed in the Chinese character reading part, each Chinese character being displayed together with the syllable length symbol, the syllable length symbols indicating that the length of pronunciation for each of the Chinese characters displayed in the word pronunciation part is even, and the length of the pronunciation is equal to or shorter than the length of pronunciation of the Chinese character displayed in the Chinese character reading part; and
a conversation pronunciation part that displays a plurality of Chinese characters including the Chinese character displayed in the Chinese character reading part, each Chinese character being displayed together with the syllable length symbol, the syllable length symbols indicating that the length of pronunciation for each of Chinese characters displayed in the conversation pronunciation part is even, and the length of the pronunciation is equal to a half of the length of pronunciation for each of the Chinese characters displayed in the word pronunciation part,
wherein the Chinese character reading part, the word pronunciation part, and the conversation pronunciation part are arranged side by side from left to right in a page in the order of the Chinese character reading part, the word pronunciation part, and the conversation pronunciation part,
wherein the syllable length symbol is a rectangular frame, each of the Chinese characters being displayed inside the frames, the width of the rectangular frames of the word pronunciation part being equal to or shorter than the rectangular frame of the Chinese character reading part, the width of the rectangular frames of the conversation pronunciation part being a half of the rectangular frame in the Chinese character reading part.

2. The printed matter of Chinese teaching material according to claim 1, further comprising:
another conversation pronunciation part that is arranged in the page and on the right side to the conversation pronunciation part together with the Chinese character reading part, the word pronunciation part, and the conversation pronunciation part,
wherein said another conversation pronunciation part displays a plurality of Chinese characters including the Chinese character displayed in the Chinese character reading part, each of the Chinese characters being displayed together with the syllable length symbol, the syllable length symbols indicating that the length of pronunciation for each of the Chinese characters is even, and the length of the pronunciation is a quarter of the length of pronunciation for each of the Chinese character displayed in the word pronunciation part,
wherein the syllable length symbol of said another conversation pronunciation part is rectangular frame, each of the Chinese characters being displayed in the frames, and the width of the rectangular frame of said another conversation pronunciation part is a quarter of the width of the rectangular frame in the Chinese character reading part.

3. The printed matter of Chinese teaching material according to claim 1, wherein Chinese characters that the pronunciations thereof are the same but the four tones thereof are different are listed together with the syllable length symbols in the Chinese character reading part.

4. The printed matter of Chinese teaching material according to claim 1, further comprising a grammar comparison part that displays conversational sentences and the Japanese translations of the conversational sentences,
wherein in the grammar comparison part, portions of different word order between Chinese and Japanese are displayed in color different from one for other characters.

5. The printed matter of Chinese teaching material according to claim 1, wherein a Chinese character that is the same as a Japanese kanji, which is a Chinese character used in Japan, is displayed in black, while a distinctive Chinese character that is different from the Japanese kanji is displayed in red.

6. A method of preparing Chinese teaching material, comprising:
arranging a Chinese character reading part that displays a Chinese character and Chinese pinyin of the Chinese character, the Chinese character being displayed together with a syllable length symbol that relatively indicates the length of the Chinese character;
arranging a word pronunciation part that displays a plurality of Chinese characters including the Chinese character displayed in the Chinese character reading part, each Chinese character being displayed together with the syllable length symbol, the syllable length symbols indicating that the length of pronunciation for each of the Chinese characters displayed in the word pronunciation part is even, and the length of the pronunciation is equal to or shorter than the length of pronunciation of the Chinese character displayed in the Chinese character reading part; and
arranging a conversation pronunciation part that displays a plurality of Chinese characters including the Chinese character displayed in the Chinese character reading part, each Chinese character being displayed together with the syllable length symbol, the syllable length symbols indicating that the length of pronunciation for each of Chinese characters displayed in the conversation pronunciation part is even, and the length of the pronunciation is equal to a half of the length of pronunciation for each of the Chinese characters displayed in the word pronunciation part,
wherein the Chinese character reading part, the word pronunciation part, and the conversation pronunciation part are arranged side by side from left to right in the order of the Chinese character reading part, the word pronunciation part, and the conversation pronunciation part,
wherein the syllable length symbol is a rectangular frame, each of the Chinese characters being displayed inside the frames, the width of the rectangular frames of the word pronunciation part being equal to or shorter than the rectangular frame of the Chinese character reading part, the width of the rectangular frames of the conversation pronunciation part being a half of the rectangular frame in the Chinese character reading part.

7. The method according to claim 6, wherein the Chinese character reading part, the word pronunciation part, and the conversation pronunciation part are arranged on a printed page.

8. The method according to claim 6, wherein the Chinese character reading part, the word pronunciation part, and the conversation pronunciation part are arranged on a display of a computer or smartphone.

9. The method according to claim 6, wherein another conversation pronunciation part is arranged on the right side to the conversation pronunciation part together with the Chinese character reading part, the word pronunciation part, and the conversation pronunciation part,
wherein said another conversation pronunciation part displays a plurality of Chinese characters including the Chinese character displayed in the Chinese character reading part, each of the Chinese characters being displayed together with the syllable length symbol, the syllable length symbols indicating that the length of pronunciation for each of the Chinese characters is even, and the length of the pronunciation is a quarter of the length of pronunciation for each of the Chinese character displayed in the word pronunciation part,
wherein the syllable length symbol of said another conversation pronunciation part is rectangular frame, each of the Chinese characters being displayed in the frames, and the width of the rectangular frame of said another conversation pronunciation part is a quarter of the width of the rectangular frame in the Chinese character reading part.

10. The method according to claim 6, wherein Chinese characters that the pronunciations thereof are the same but the four tones thereof are different are listed together with the syllable length symbols in the Chinese character reading part.

11. The method according to claim 6, further comprising:
arranging a grammar comparison part that displays conversational sentences and the Japanese translations of the conversational sentences,
wherein in the grammar comparison part, portions of different word order between Chinese and Japanese are displayed in color different from one for other characters.

12. The method according to claim 6, wherein a Chinese character that is the same as a Japanese kanji, which is a Chinese character used in Japan, is displayed in black, while a distinctive Chinese character that is different from the Japanese kanji is displayed in red.
